(19) United States
(12) Patent Application Publication
(10) Pub. No.: US 2024/0047774 A1
(43) Pub. Date: Feb. 8, 2024

(54) Secondary Battery And Monitoring System Of Secondary Battery

(71) Applicant: Semiconductor Energy Laboratory Co., Ltd., Kanagawa-ken (JP)

(72) Inventors: Takeshi OSADA, Isehara, Kanagaw (JP); Yosuke TSUKAMOTO, Atsugi, Kanagawa (JP); Takayuki IKEDA, Atsugi, Kanagawa (JP)

(73) Assignee: Semiconductor Energy Laboratory Co., Ltd., Kanagawa-ken (JP)

(21) Appl. No.: 18/266,663

(22) PCT Filed: Dec. 2, 2021
(86) PCT No.: PCT/IB2021/061205

§ 371 Date: Jun. 12, 2023

(30) Foreign Application Priority Data
Dec. 16, 2020 (JP) 2020-208486

(51) Int. Cl. H01M 10/48; H01M 10/42

(52) U.S. Cl. CPC H01M 10/488; H01M 10/486; H01M 10/425; H01M 2220/20; H01M 2010/4271

(57) ABSTRACT

One embodiment of the present invention is to provide a highly safe monitoring system for a secondary battery which ensures safety by warning a user when detecting an abnormality in the secondary battery, for example, when detecting a phenomenon that impairs safety of the secondary battery in an early stage. The monitoring system uses an imaging device which captures images of an external view of the secondary battery. Furthermore, for facilitating an abnormality detection, temperature sensitive paint is either sprayed or applied on at least part of a surface of an exterior body of the secondary battery. In addition, a light source for irradiating the temperature sensitive paint with light is also provided. With this structure, the abnormal portion can emit light (or exhibit a color) in the case where abnormal heat generation occurs locally, whereby the imaging device can distinguish an abnormal portion from image data by the imaging device. Accordingly, a danger can be noticed by the image data before ignition or an explosion occurs.

### TECHNICAL FIELD

One embodiment of the present invention relates to an object, a method, or a manufacturing method. Alternatively, the present invention relates to a process, a machine, manufacture, or a composition of matter. One embodiment of the present invention relates to a semiconductor device, a display device, a light-emitting device, a power storage device, a lighting device, an electronic device, or a manufacturing method thereof. In addition, one embodiment of the present invention relates to a method for estimating the state of charge of a power storage device, a system for estimating the state of charge of a power storage device, and an abnormality detection method. In particular, one embodiment of the present invention relates to the system for estimating the state of charge of the power storage device and an abnormality detection system of a power storage device.

Note that power storage devices in this specification refer to any elements and devices having a function of storing power. For example, the power storage devices include a storage battery of a lithium ion secondary battery (also referred to as a secondary battery), a lithium ion capacitor, a nickel hydrogen battery, an all-solid-state battery, and an electric double layer capacitor.

In addition, an abnormality detection system can be constructed by using an AI (Artificial Intelligence), and one embodiment of the present invention relates to a neural network and an abnormality detection system of a power storage device using the neural network. Another embodiment of the present invention relates to a vehicle using a neural network. Another embodiment of the present invention relates to an electronic device using a neural network. One embodiment of the present invention is not limited to a vehicle, and can also be applied to a power storage device for storing electric power obtained from power generation facility such as a solar power generation panel provided in a structure body and relates to a system for detecting abnormalities in facilities.

Note that power storage devices in this specification refer to any elements and devices having a function of storing power. For example, the power storage device includes a storage battery of a lithium ion secondary battery (also referred to as a secondary battery), a lithium ion capacitor, a nickel hydrogen battery, an all-solid-state battery, and an electric double layer capacitor.

### BACKGROUND ART

Electronic devices carried around by users or electronic devices worn by users have been actively developed.

Electronic devices carried around by users or electronic devices worn by users operate using primary batteries or secondary batteries, which are examples of a power storage device, as power sources. It is desired that electronic devices carried around by users be used for a long time; thus, a high-capacity secondary battery can be used. Since high-capacity secondary batteries are large in size, there is a problem in that their incorporation in electronic devices increases the weight of the electronic devices. In view of the problem, development of small or thin high-capacity secondary batteries that can be incorporated in portable electronic devices is being pursued.

In particular, demand for lithium-ion secondary batteries with high output and high energy density has rapidly grown with the development of the semiconductor industry, for portable information terminals such as mobile phones, smartphones, and laptop computers, portable music players, digital cameras, medical equipment, next-generation clean energy vehicles such as hybrid electric vehicles (HVs), electric vehicles (EVs), and plug-in hybrid electric vehicles (PHVs), and the like, and the lithium-ion secondary batteries are essential for today's information society as rechargeable energy supply sources.

While a lithium-ion secondary battery has high capacity, the temperature inside the battery might increase in the case where abnormal heat generation occurs due to an internal short-circuit or overcharge.

Patent Document 1 discloses a charge control circuit which detects that the ambient temperature of a battery of an electric vehicle is out of the range of a normal operation and controls a temperature so that the temperature is within an appropriate range.

### REFERENCE

### Patent Document

[Patent Document 1] WO2020/084386

### SUMMARY OF THE INVENTION

### Problems to be Solved by the Invention

In general, secondary batteries are examined at the time of shipment, and secondary batteries in which an abnormality has occurred are excluded. The number of secondary batteries in which an abnormality occurs has decreased with an improved manufacturing technology of a secondary battery. However, it is difficult to reduce, to zero, the number of secondary batteries in which an abnormality occurs after the long-term use.

An object is to provide a secondary battery that facilitates abnormality detection.

An object is to ensure safety by detecting an abnormality in a secondary battery without destruction, for example, by detecting a phenomenon that impairs the safety of the secondary battery early, and giving a warning to a user.

Another object is to provide a highly safe monitoring system for a secondary battery.

### Means for Solving the Problems

To be highly safe, a monitoring system for a secondary battery includes an imaging device that captures images of an external view of the secondary battery.

Temperature sensitive paint is either sprayed or applied on at least part of a surface of an exterior body of the secondary battery to facilitate abnormality detection. Furthermore, a light source for irradiating the temperature sensitive paint with light is also provided. This makes an abnormal portion emit light (or exhibit a color) in the case where abnormal heat generation occurs locally, which allows the imaging device to determine the abnormal portion from the image data. Accordingly, a danger can be noticed from the image data before ignition or an explosion occurs. The image data may be data of either a still image or a moving image. In the case of the moving image, a danger can be determined in accordance with the rate at which the temperature increases per unit time. In a lithium-ion secondary battery, a negative electrode and an electrolyte solution react at 80° C. or more; a separator is melted and a short-circuit occurs when the temperature exceeds 140° C.; and at 200° C. or more, a material of a positive electrode is thermally decomposed to release oxygen, and vaporized electrolyte solution causes intense burning, so that a phenomenon called thermal runaway occurs. In the case of the lithium-ion secondary battery, it is necessary to determine accurately whether the sign of thermal runaway is seen or the temperature rises incidentally by current discharge in the range of 45° C. to 80° C. at which reaction between the electrolyte solution and the negative electrode begins.

An invention disclosed in this specification is a secondary battery including a positive electrode, a negative electrode, and an exterior body surrounding at least part of the positive electrode, the negative electrode, and a surface of the exterior body is provided with temperature sensitive paint.

In the above structure, the exterior body is a laminate film or a metal housing.

In addition, a plurality or kinds of monitoring systems can be combined to each other to obtain a highly safe monitoring system for a secondary battery. For example, the monitoring system can be combined with a method of monitoring a temperature inside the secondary battery. A T terminal (a temperature sensing terminal) provided in a battery pack is an analog signal output terminal of a temperature sensor, and a thermistor, whose resistance value is detected with a circuit, is connected between the negative terminal and the T terminal; charge is stopped in the case where the resistance value is out of a range. The temperature is calculated from the resistance value.

In addition, captured image data of the exterior body of the secondary battery, and an internal temperature, voltage, and current of the secondary battery are learned in a neural network portion as learning data, whereby a portion of abnormal heat generation can be estimated. Examples of the portion of abnormal heat generation include heat generation caused by bending of a current collector due to an impact and an internal short-circuit due to dendrite that is formed at the time of charge in a low temperature environment.

In this specification, one invention is a monitoring system using a neural network portion. The monitoring system includes a secondary battery including a positive electrode, negative electrode, and an exterior body surrounding at least part of the positive electrode and the negative electrode, a light source for irradiating the exterior body with light, an imaging device for capturing a surface of the exterior body, and a neural network portion for estimating abnormal heat generation on the surface of the exterior body. In the monitoring system, which is for the secondary battery, a temperature change on the surface of the exterior body is captured by the imaging device and an abnormality in the secondary battery is estimated.

In the monitoring system, temperature sensitive paint is contained on the surface of the exterior body of the secondary battery. An abnormal portion emits light (or exhibits a color) before thermal runaway occurs in the case where the tendency for abnormal heat generation to occur locally appears, which makes it possible to estimate the abnormal portion and a secondary battery with an abnormality.

In the above-described monitoring system, one or more selected from image data captured by the imaging device, an internal temperature of the secondary battery, and voltage, electric power, and current of the secondary battery is used as data learned in the neural network portion and data on the secondary battery.

Abnormal heat generation of a secondary battery that is difficult to predict may lead to serious accidents such as ignition. Especially such abnormal heat generation in a vehicle can lead to loss of human lives. Vehicles incorporate a large number of secondary batteries in many cases. Furthermore, also in the case of a secondary battery equipped in a house or a factory, abnormal heat generation of the secondary battery can lead to loss of human lives. It is desirable that the secondary battery in the vehicle or the house be monitored around the clock. The use of the neural network portion enables precise monitoring with noise removed.

In addition, after abnormal heat generation occurs, the abnormal portion can be desirably identified remotely. Identifying the abnormal heat generation from a remote location is possible by providing an imaging device in the vicinity of a secondary battery and transferring the image data. Accordingly, even when a large-scale arithmetic circuit is not mounted on an electric vehicle, image data may be transmitted to be subjected to an abnormal analysis by a car dealer and the electric vehicle and a driver receive the result, so that the driver can behave on the basis of the result. Checking an abnormal portion directly by the driver should be avoided to prevent an electric shock occurring when the electric vehicle is handled incorrectly. This invention is highly advantageous also in maintenance; a state of the secondary battery can be instantly checked with data from the imaging device that captures an external view of the secondary battery.

With the structure of the present invention, the imaging device can monitor image data, so that abnormality detection can be performed further precisely while data on electrical characteristics is monitored at the same time. Accordingly, an abnormal secondary battery can be detected in advance more reliably than before.

### Effect of the Invention

Abnormal heat generation can be identified in advance by an imaging device with a use of a secondary battery in which temperature sensitive paint is either sprayed or applied on at least part of a surface of an exterior body. In addition, safety can be further enhanced by the monitoring in a neural network portion instead of the monitoring by a driver.

### BRIEF DESCRIPTION OF THE DRAWINGS

FIG. 1 is an example of a block diagram illustrating one embodiment of the present invention.

FIG. 2A is a diagram illustrating an external view of a secondary battery of one embodiment of the present invention, and FIG. 2B is an example of a cross-sectional structure of the secondary battery.

FIG. 3A illustrates an example of a cylindrical secondary battery. FIG. 3B illustrates an example of a cylindrical secondary battery. FIG. 3C illustrates an example of a plurality of cylindrical secondary batteries.

FIG. 4A and FIG. 4B are diagrams illustrating examples of a secondary battery, and FIG. 4C is a diagram illustrating a state of the inside of the secondary battery.

FIG. 5A to FIG. 5C are diagrams illustrating an example of a secondary battery.

FIG. 6 is a diagram showing an example of a flow chart of a monitoring system.

FIG. 7A to FIG. 7E are diagrams illustrating examples of transport vehicles.

FIG. 8A and FIG. 8B are diagrams illustrating power storage devices of one embodiment of the present invention.

### MODE FOR CARRYING OUT THE INVENTION

Embodiments of the present invention will be described in detail below with reference to the drawings. Note that the present invention is not limited to the following description, and it is readily understood by those skilled in the art that modes and details of the present invention can be modified in various ways. In addition, the present invention should not be construed as being limited to the description of the following embodiments.

In this specification and the like, charge refers to transfer of lithium ions from a positive electrode to a negative electrode in a battery and transfer of electrons from a positive electrode to a negative electrode in an external circuit. For a positive electrode active material, extraction of lithium ions is called charge. A positive electrode active material with a charge depth of greater than or equal to 0.7 and less than or equal to 0.9 may be referred to as a positive electrode active material charged with high voltage.

Similarly, discharge refers to transfer of lithium ions from a negative electrode to a positive electrode in a battery and transfer of electrons from a negative electrode to a positive electrode in an external circuit. For a positive electrode active material, insertion of lithium ions is called discharge. Furthermore, a positive electrode active material with a charge depth of less than or equal to 0.06 or a positive electrode active material from which more than or equal to 90% of a charge capacity is discharged from a state where the positive electrode active material is charged with high voltage is referred to as a sufficiently discharged positive electrode active material.

A secondary battery includes a positive electrode and a negative electrode, for example. A positive electrode active material is a material included in the positive electrode. The positive electrode active material is a substance that performs a reaction contributing to a charge and discharge capacity, for example. Note that the positive electrode active material may partly contain a substance that does not contribute to the charge and discharge capacity.

In this specification, the positive electrode active material of one embodiment of the present invention is expressed as a positive electrode material or a secondary battery positive electrode material in some cases. In this specification, the positive electrode active material of one embodiment of the present invention preferably includes a compound. In this specification, the positive electrode active material of one embodiment of the present invention preferably includes a composition. In this specification, the positive electrode active material of one embodiment of the present invention preferably includes a composite.

A discharge rate refers to the relative ratio of current at the time of discharge to battery capacity and is expressed in a unit C. A current corresponding to 1 C in a battery with a rated capacity X (Ah) is X (A). The case where discharge is performed with a current of 2X (A) is rephrased as to perform discharge at 2 C, and the case where discharge is performed with a current of X/5 (A) is rephrased as to perform discharge at 0.2 C. The same applies to a charge rate; the case where charge is performed with a current of 2X (A) is rephrased as to perform charge at 2 C, and the case where charge is performed with a current of X/5 (A) is rephrased as to perform charge at 0.2 C.

Constant-current charge refers to, for example, a method in which charge is performed at a constant charge rate. Constant voltage charge refers to a charge method in which charge voltage is made constant when reaching the upper voltage limit, for example. Constant-current discharge refers to, for example, a method in which discharge is performed at a constant discharge rate.

### Embodiment 1

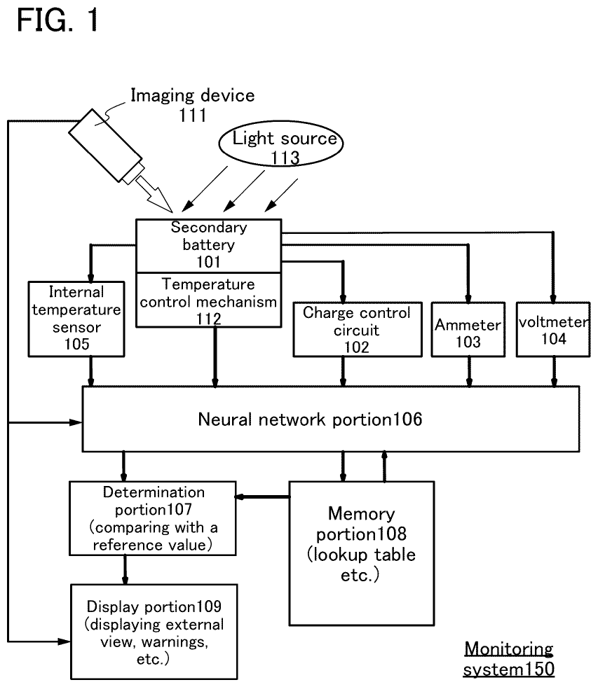

In this embodiment, an example of a monitoring system 150 of one embodiment of the present invention is described with reference to FIG. 1.

FIG. 1 is a block diagram of the monitoring system 150 which includes a plurality of devices for monitoring a secondary battery 101 and estimating occurrence of an abnormality. An example in which the secondary battery 101 is electrically connected to a charge control circuit 102, an ammeter 103, a voltmeter 104, and an internal temperature sensor 105 is shown.

Although one secondary battery 101 is shown in FIG. 1, electric vehicles generally incorporate a plurality of the secondary batteries 101 which are connected in series or in parallel with a protection circuit provided and are used as a battery pack (also referred to as an assembled battery). The battery pack means an exterior body (a metal can or a film exterior body (also referred to as a laminate film)) in which a plurality of secondary batteries and a predetermined circuit are stored together for easy handling of the secondary battery 101. The battery pack includes an ECU (Electronic Control Unit) in order to manage the operation state.

Either one ammeter 103 or one voltmeter 104 is provided for every plural secondary batteries in many cases, and the charge control circuit 102 is provided for all the secondary batteries in some cases.

An imaging device 111 that can capture an external view of the secondary battery 101 can obtain image data by a light source 113 turned on.

In particular, in the case where the monitoring system 150 is incorporated in an electric vehicle, it is preferable that a driver can recognize whether an abnormality occurs or not on a display portion 109 and check the external view of the secondary battery 101 when the vehicle stops in the case where the vehicle is crashed due to some accident. When an abnormality is recognized visually, the imaging device is driven with a power source different form the secondary battery 101, in which case the driver can safely get out of the vehicle without using the secondary battery 101 that is recognized as abnormal. After being visually recognized as normal, the secondary battery 101 of the electric vehicle starts to be supplied with electric power, whereby safety can be ensured. In addition, in the case of a traffic accident of an electric vehicle, a secondary battery may explode after crash, so that the background such as whether the explosion has occurred before crash and caused the accident or whether the explosion has occurred after crash, sometimes goes missing. The monitoring system 150 incorporated in an electric vehicle can capture an image of the secondary battery like a dashboard camera; accordingly, the monitoring system may sense impact and capture an image at the same time, and record image data or transmit the image data to a car dealer.

Furthermore, the imaging device 111 can be used to visually recognize an influence on the secondary battery 101 also in the case where the electric vehicle gets flooded. In the case of driving on a submerged road, a gasoline vehicle becomes undriveable when exhaustion is impossible due to water entering an exhaust outlet, whereas an electric vehicle can drive in the case where no water enters the battery pack part arranged in a sealed space and an electric cable is not exposed. In addition, the driver can judge safety and does not operate the secondary battery 101 in the case where water entering the battery pack part can be recognized by the imaging device 111. In the electric vehicle, the sealed space may be filled with an inert gas typified by a nitrogen gas, and the imaging device, the light source, and the battery pack may be placed. Since oxygen around the battery pack might facilitate a reaction, the space around the battery pack may be filled with a nitrogen gas or an argon gas to further enhance the safety level.

Furthermore, temperature sensitive paint is either sprayed or applied on at least part of a surface of the exterior body of the secondary battery 101 to increase visibility. When the temperature sensitive paint is used, an LED light source with a wavelength of 470 nm is used as the light source 113. When the temperature sensitive paint is irradiated with an excitation light with a specific wavelength (a wavelength range of 400 nm to 600 nm), the paint emits light and the emission intensity depends on the temperature of the surface where the paint is applied. The temperature sensitive paint is made of a dye molecule, a binder, and a solvent, and the characteristics are determined by the combination of the dye and the binder. For the dye of the temperature sensitive paint, an aromatic hydrocarbon, a ruthenium complex, or an europium complex of rhodamine-B is used. As the binder, a resin material which does not have oxygen permeability is preferable; poly(methacryl acrylate), polyurethane, or poly(acrylic acid) is used. An organic solvent such as ethanol is used as the solvent and the temperature sensitive paint is applied by spraying.

A portion of the secondary battery where the temperature sensitive paint is applied is a side surface or the top surface of the exterior body of the secondary battery 101. Accordingly, the imaging device 111 captures the part of the surface of the exterior body of the secondary battery 101 and monitors the temperature of the part of the surface. The imaging device 111 monitors the temperature of the surface of the exterior body of the secondary battery 101, specifically a state of the heat generation at a temperature within the range of 45° C. to 80° C.

In the case of monitoring when the electric vehicle stops, the imaging device 111, the light source 113, and the display portion 109 are supplied with electric power not from the secondary battery 101 but from another power source (e.g. a lead-acid battery). This enables monitoring at the time when power supply from the secondary battery is stopped as well as at the time of charge or discharge of the secondary battery 101. Although the light source 113 may be always on, the light source may be turned on only when an image is captured by the imaging device 111 so as to reduce power consumption. In the case of monitoring when the electric vehicle stops, the system to examine a state of the secondary battery 101 can be referred to as a vehicle state evaluation system.

In the case of monitoring when the electric vehicle drives, the power sources of the imaging device 111, the light source 113, and the display portion 109 may be switched to the secondary battery 101 in order that electric power can be supplied from the secondary battery 101. Switching of power supply is performed in a data processing portion (not illustrated). The data processing portion includes a CPU (Central Processing Unit), a ROM, a RAM, and the like. The CPU reads out a program corresponding to processing content from a memory portion or the ROM, develops it to the RAM, and runs the developed program, thereby executing predetermined processing.

The internal resistance of the secondary battery 101 depends on a temperature and can be accordingly monitored by the internal temperature sensor 105. Needless to say, the temperature of the secondary battery 101 can be measured by the internal temperature sensor 105 without using the imaging device 111, in which case, however, the safety level is insufficient due to a defect of a temperature sensor or a sensing portion being limited.

The internal temperature sensor 105 monitors the internal temperature of the secondary battery 101. When the internal temperature sensor 105 is used with the imaging device 111, the monitoring system 150 having an enhanced level of safety can be obtained.

Furthermore, an output current of the secondary battery 101 can be measured by the ammeter 103, and an output voltage of the secondary battery 101 can be measured by the voltmeter 104. Needless to say, without using the imaging device 111, an abnormality can be detected on the basis of an electrical characteristic value obtained by the ammeter 103 or the voltmeter 104, in which case, however, the safety level is insufficient. Since either one ammeter 103 or one voltmeter 104 is provided for every plural secondary batteries in many cases, it is difficult to identify only an abnormal secondary battery. When the ammeter 103 or the voltmeter 104 is used with the imaging device 111, the monitoring system 150 having an enhanced level of safety can be obtained.

The temperature of the secondary battery 101 may be controlled with a temperature control mechanism 112 such as a heat sink or a heater. Since the temperature sensitive paint is not applied to the heater, the imaging device 111 does not mistakenly detect the temperature of the heater. The temperature sensitive paint can be applied selectively, which is advantageous in performing monitoring selectively. In addition, the secondary battery 101 may be cooled or heated by the temperature control mechanism 112 on the basis of the image data from the imaging device 111 obtained by the light emission of the temperature sensitive paint.

Neural network processing can be performed on the basis of the image data obtained by the imaging device 111, so that occurrence of an abnormality can be estimated.

In that case, instead of the CPU in the electric vehicle, one integrated IC chip including a GPU (Graphics Processing Unit) and a PMU (Power Management Unit) may be used.

A program of software running an inference program for the neural network processing of the estimation can be described in a variety of programing languages such as Python, Go, Perl, Ruby, Prolog, Visual Basic, C, C++, Swift, Java (registered trademark), and .NET. Moreover, an application may be made using a framework such as Chainer (it can be used with Python), Caffe (it can be used with Python and C++), and TensorFlow (it can be used with C, C++, and Python).

An operating environment of the monitoring system 150 is set to at least execute the software of python.

It is desirable that an estimation device perform estimation based on data whose amount is as small as possible and output an estimated value with high accuracy. With the small amount of data, the amount of data for learning to be accumulated can be reduced, resulting in a reduction in memory capacity for storing the data. Moreover, the small amount of data makes it possible to reduce a time required for arithmetic processing.

The neural network portion 106 is achieved by software calculation with a microcontroller. The microcontroller is obtained by incorporating a computer system into one integrated circuit (IC). When the calculation scale or data to be handled is large, a plurality of ICs are combined to form the neural network portion 106. It is preferable to use a microcontroller incorporating Linux (registered trademark) that enables use of free software, in which case the total cost of forming the neural network portion 106 can be reduced. Other OSs (operating systems), without limited to Linux (registered trademark), may be used.

Learning of the neural network portion 106 illustrated in FIG. 1 is described below.

A program is created using python under an operating environment of Linux (registered trademark). The image data obtained by the imaging device 111 is used as the learning data. The image data at the time of charge or the image data at the time of discharge is accumulated, trend of change of the image data corresponding to a temperature change is analyzed, and weighting is performed. The weighting functions as a filter. As the filter, a convolutional filter of a convolutional neural network (CNN) can be used, for example. Alternatively, an image processing filter such as an edge extraction filter can be used. Moreover, data on a current value, a voltage value, and an internal temperature at the time of charge may be added to the learning data. Alternatively, data on a current value, a voltage value, and an internal temperature at the time of discharge may be added to the learning data. The neural network portion 106 estimates whether an abnormality occurs or not on the basis of these learning data.

When the estimation in the neural network portion 106 ends, the estimated value and the reference value are compared in a determination portion 107, so that abnormality detection can be performed. As the reference value, one of reference values stored in advance in a lookup table in a memory portion 108 may be selected. The data stored in the lookup table is data assigning output corresponding to input. The data includes arrangement of a plurality of parameters and is data for a comparison table. The lookup table also includes data assigning output corresponding to input with use of a function such as a formula. When determination of an abnormality can be made from a comparison result of a large difference between the estimated value and the reference value, the display portion 109 can perform display of abnormality detection, which is one of structures of the monitoring system 150. When the display portion 109 is shared with a display portion of an automotive navigation system, warnings of an abnormality (including a status or alert) in a secondary battery are displayed concurrently with a map, which can call attention to a driver. In the case where the neural network portion 106 judges the secondary battery as dangerous as a result of the abnormality detection, the power source may be forcibly shut off in the system.

Although the description is given to a vehicle that a driver operates in this embodiment, this embodiment is not limited thereto. With a combination of an ECU performing image processing with a radar or a camera taking images of the periphery of the vehicle, this embodiment can be applied to a vehicle that can perform semi-automatic operation or a vehicle that can perform full automatic operation.

This embodiment is not limited to a vehicle that a driver operates, and can also be applied to a home-use power storage device.

### Embodiment 2

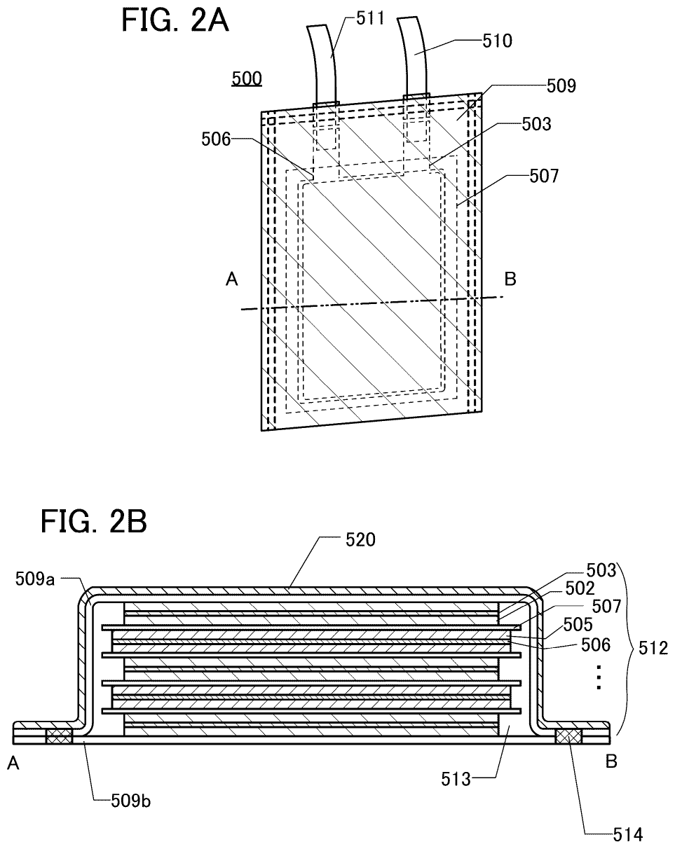

In this embodiment, an example of a laminated secondary battery is illustrated in FIG. 2A and FIG. 2B. FIG. 2A is an external view and FIG. 2B is a schematic cross-sectional view taken along a dotted line AB in FIG. 2A.

A secondary battery 500 includes a positive electrode 503, a negative electrode 506, a separator 507, an exterior body 509, a positive electrode lead electrode 510, and a negative electrode lead electrode 511.

A manufacturing process of the laminated secondary battery 500 is described below.

First, the positive electrode 503, the negative electrode 506, and the separator 507 are prepared. A positive electrode active material layer 502 is included over a positive electrode current collector. The positive electrode 503 preferably includes a tab region where the positive electrode current collector is exposed. The negative electrode 506 includes a negative electrode active material layer 505 over a negative electrode current collector. The negative electrode 506 preferably includes a tab region where the negative electrode current collector is exposed.

Next, the separator 507 is placed over the positive electrode 503 to overlap with the entire surface of the positive electrode 503. After that, a stack of the positive electrode 503, the separator 507, and the negative electrode 506 is further stacked, whereby a stack 512 illustrated in FIG. 2B can be manufactured.

Next, the positive electrode 503, the separator 507, and the negative electrode 506 are sealed with an exterior body 509a and an exterior body 509b. The exterior bodies 509a and 509b are subjected to sealing by thermocompression bonding in a region 514. Before the sealing, a nonaqueous electrolyte solution 513 is put in a region surrounded by the exterior body 509a and the exterior body 509b. The sealing may be performed after the nonaqueous electrolyte solution 513 is degassed. In addition, although FIG. 2B schematically illustrates a space including the nonaqueous electrolyte solution 513, in practice, the space is enclosed to be almost eliminated by sealing.

Note that FIG. 2A illustrates the exterior body 509a and the exterior body 509b as the exterior body 509. Although FIG. 2A illustrates that three sides of the exterior body 509a and the exterior body 509b are sealed (which is referred to as three-side sealing in some cases) by folding one laminate film, this embodiment is not limited thereto; four sides of the exterior body 509a and the exterior body 509b may be sealed (which is referred to as four-side sealing in some cases) with the use of two laminate films.

After the sealing, the temperature sensitive paint is sprayed on a part of a surface of the exterior body 509a with a spray gun, so that a temperature sensitive paint layer 520 is provided. The temperature sensitive paint layer 520 is desirably formed with a uniform thickness.

In the case of heat generation, a surface temperature of the exterior body of the laminated secondary battery 500 more easily changes than that of a metal can because the laminate film is thin. Accordingly, abnormality detection is easily performed by obtaining image data of the light emission from the temperature sensitive paint layer 520 with the use of an imaging device. The laminated secondary battery 500 can have a large size, and also in that case, heat generation due to a local short-circuit that is difficult to measure with the internal temperature sensor can also be detected.

Although FIG. 2B illustrates the laminate film having a small thickness, in practice, the thickness of the laminate film is approximately 100 μm, and the thickness of the temperature sensitive paint layer 520 is greater than or equal to 100 nm and less than or equal to 10 μm. In this embodiment, the temperature sensitive paint layer 520 is formed to have a thickness of 1 μm using a ruthenium complex and poly(acryl acid) that is a binder. The image data can be obtained by the light emission from the temperature sensitive paint layer 520 with the use of a high-speed CCD camera for visible light.

The laminate film is a sheet made of a flexible base; a stack, a metal film one surface or both surfaces of which are provided with an adhesive layers (also referred to as a heat-seal layers), is used as the sheet. As the adhesive layer, a heat-seal resin film containing polypropylene or polyethylene is used. In this embodiment, a metal sheet (also referred to as a laminate film), aluminum foil whose top surface is provided with a nylon resin and whose rear surface is provided with a stack of an acid-proof polypropylene film and a polypropylene film, is used as the sheet.

The separator 507 has a thickness of approximately 15 μm to 30 μm, the current collector of the positive electrode 503 has a thickness of approximately 10 μm to 40 μm, the positive electrode active material layer 502 has a thickness of approximately 50 μm to 100 μm, the negative electrode active material layer 505 has a thickness of approximately 50 μm to 100 μm, and the current collector of the negative electrode 506 has a thickness of approximately 5 μm to 40 μm.

### Embodiment 3

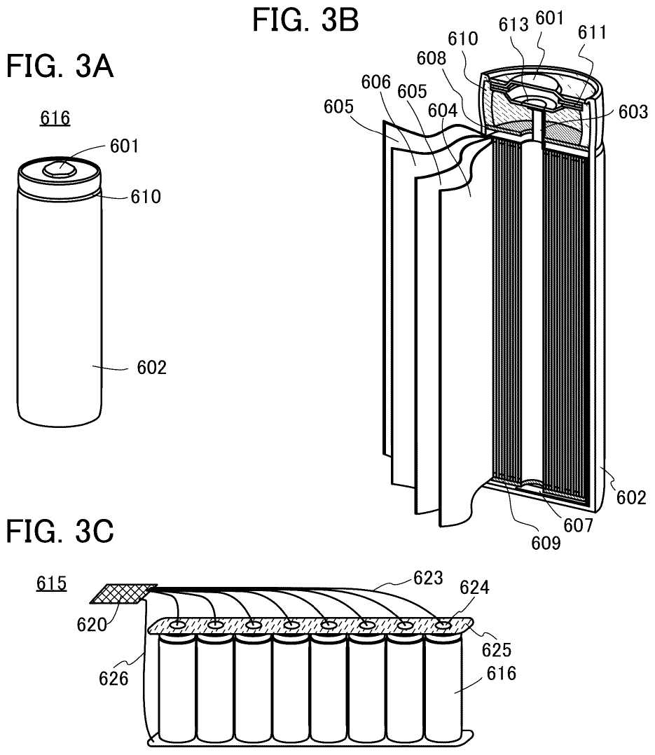

Although the example of a laminated secondary battery is described in Embodiment 2, in this embodiment, examples of a cylindrical secondary battery is described with reference to FIG. 3A. As illustrated in FIG. 3A, a cylindrical secondary battery 616 includes a positive electrode cap (battery cap) 601 on the top surface and a battery can (outer can) 602 on the side surface and the bottom surface. The positive electrode cap 601 and the battery can (outer can) 602 are insulated from each other by a gasket (insulating gasket) 610.

FIG. 3B is a schematic cross-sectional diagram of a cylindrical secondary battery. The cylindrical secondary battery illustrated in FIG. 3B includes the positive electrode cap (battery cap) 601 on the top surface and the battery can (outer can) 602 on the side surface and bottom surface. The positive electrode cap and the battery can (outer can) 602 are insulated from each other by the gasket (insulating gasket) 610.

Inside the battery can 602 having a hollow cylindrical shape, a battery element in which a strip-like positive electrode 604 and a strip-like negative electrode 606 are wound with a separator 605 located therebetween is provided. Although not illustrated, the battery element is wound around the central axis. One end of the battery can 602 is closed and the other end thereof is opened. For the battery can 602, a metal having corrosion resistance to an electrolyte solution, such as nickel, aluminum, or titanium, an alloy of such a metal, or an alloy of such a metal and another metal (e.g., stainless steel) can be used. Alternatively, the battery can 602 is preferably covered with nickel or aluminum in order to prevent corrosion due to the electrolyte solution. Inside the battery can 602, the battery element in which the positive electrode, the negative electrode, and the separator are wound is provided between a pair of insulating plates 608 and 609 that face each other. Furthermore, a nonaqueous electrolyte solution (not illustrated) is injected inside the battery can 602 provided with the battery element.

Since a positive electrode and a negative electrode that are used for a cylindrical secondary battery are wound, active materials are preferably formed on both surfaces of a current collector.

A positive electrode terminal (positive electrode current collecting lead) 603 is connected to the positive electrode 604, and a negative electrode terminal (negative electrode current collecting lead) 607 is connected to the negative electrode 606. A metal material such as aluminum can be used for both the positive electrode terminal 603 and the negative electrode terminal 607. The positive electrode terminal 603 and the negative electrode terminal 607 are resistance-welded to a safety valve mechanism 613 and the bottom of the battery can 602, respectively. The safety valve mechanism 613 is electrically connected to the positive electrode cap 601 through a PTC element (positive temperature coefficient) 611. The safety valve mechanism 613 cuts off electrical connection between the positive electrode cap 601 and the positive electrode 604 when the internal pressure of the battery exceeds a predetermined threshold value. The PTC element 611, which is a thermally sensitive resistor whose resistance increases as temperature rises, limits the amount of current by increasing the resistance, in order to prevent abnormal heat generation. Barium titanate (BaTiO₃)-based semiconductor ceramics can be used for the PTC element.

FIG. 3C illustrates an example of a power storage system 615. The power storage system 615 includes a plurality of secondary batteries 616. The positive electrodes of the secondary batteries are in contact with and electrically connected to conductors 624 isolated by an insulator 625.

A temperature sensitive paint layer is applied to the side surface (curved surface) of the battery can 602, whereby a monitoring system in which a state of heat generation is captured and monitored from the direction of the side surface by the imaging device is provided.

Alternatively, the temperature sensitive paint layer is applied to the insulator 625 provided in the vicinity of the battery can 602, whereby a monitoring system in which a state of heat generation is monitored from the above by the imaging device may be provided. In this case, the temperature sensitive paint layer is provided on the surface of an object so that a temperature change of the battery can 602 can be monitored by the imaging device through the object (the insulator 625). In this manner, monitoring can be performed indirectly by the imaging device through the object which is provided over the exterior body and provided with the temperature sensitive paint layer. However, the object can be regarded as a part of the exterior body in some cases. The object is not limited to the insulator, and can be a conductive plate to which a plurality of batteries is connected and which is provided with a temperature sensitive paint layer; in that case, the temperature change of the battery can 602 can be monitored by the imaging device through the conductive plate; however, it becomes difficult to determine which of the secondary batteries is abnormal, leading to a reduction in accuracy.

The conductor 624 is electrically connected to a control circuit 620 through a wiring 623. The negative electrodes of the secondary batteries are electrically connected to the control circuit 620 through a wiring 626. As the control circuit 620, a charge and discharge control circuit for performing charge and discharge or a protection circuit for preventing overcharge or overdischarge can be used.

This embodiment can be freely combined with the other embodiments.

### Embodiment 4

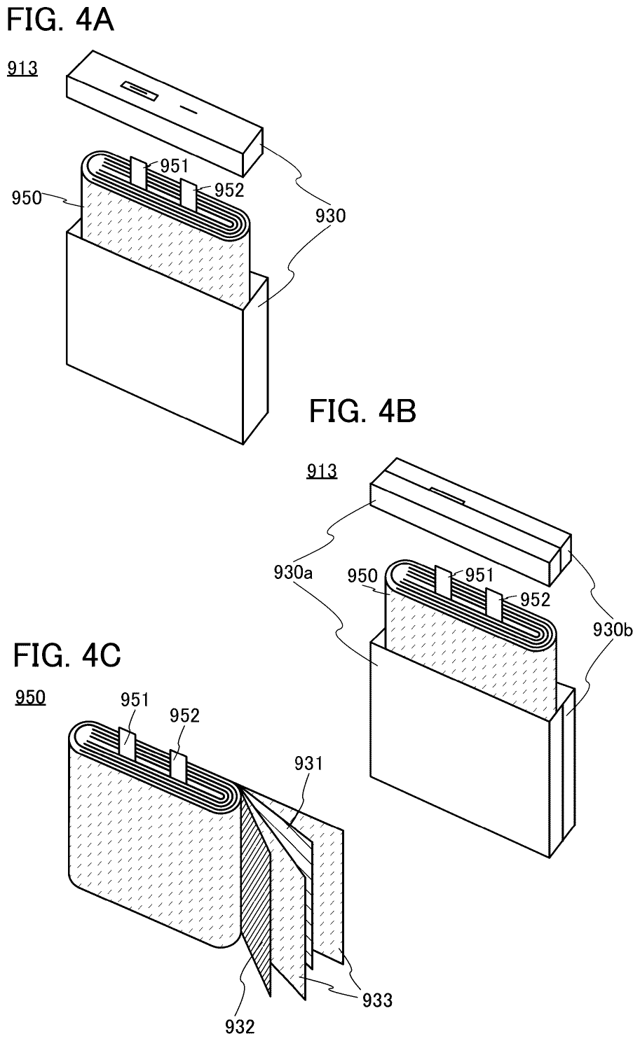

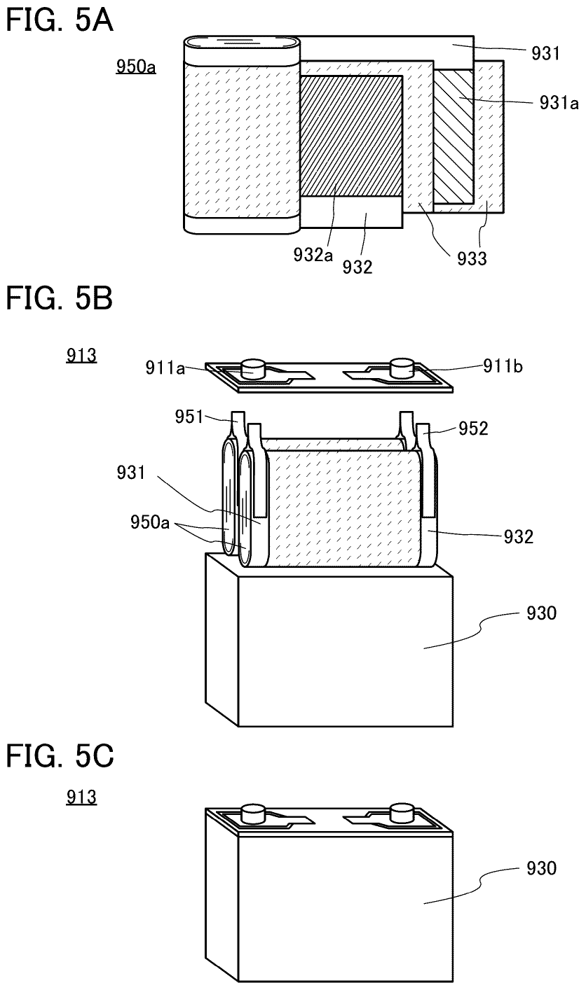

Although examples of a cylindrical secondary battery are described in Embodiment 3, in this embodiment, examples of rectangular secondary batteries will be described with reference to FIG. 4 and FIG. 5.

A secondary battery 913 illustrated in FIG. 4A includes a wound body 950 provided with a terminal 951 and a terminal 952 inside a housing 930. The wound body 950 is immersed in an electrolyte solution inside the housing 930. The terminal 952 is in contact with the housing 930. The use of an insulator inhibits contact between the terminal 951 and the housing 930. Note that in FIG. 4A, the housing 930 divided into two pieces is illustrated for convenience; however, in the actual structure, the wound body 950 is covered with the housing 930, and the terminal 951 and the terminal 952 extend to the outside of the housing 930. For the housing 930, a metal material (e.g., aluminum) or a resin material can be used.

Note that as illustrated in FIG. 4B, the housing 930 in FIG. 4A may be formed using a plurality of materials. For example, in the secondary battery 913 in FIG. 4B, a housing 930a and a housing 930b are attached to each other, and the wound body 950 is provided in a region surrounded by the housing 930a and the housing 930b.

For the housing 930a, an organic resin or an insulating material can be used. In particular, when a material such as an organic resin is used for the surface on which an antenna is formed, blocking of an electric field by the secondary battery 913 can be inhibited. When an electric field is blocked little by the housing 930a, an antenna may be provided inside the housing 930a. For the housing 930b, a metal material can be used, for example.

Since the housing 930b corresponds to the exterior body, the temperature sensitive paint layer is applied to a part of a surface of the housing 930b, whereby the state of heat generation can be captured by the imaging device.

FIG. 4C illustrates the structure of the wound body 950. The wound body 950 includes a negative electrode 931, a positive electrode 932, and separators 933. The wound body 950 is obtained by winding a sheet of a stack in which the negative electrode 931 and the positive electrode 932 overlap with the separator 933 therebetween. Note that a plurality of stacks each including the negative electrode 931, the positive electrode 932, and the separators 933 may be further stacked.

The secondary battery 913 may include a wound body 950a illustrated in FIG. 5. The wound body 950a illustrated in FIG. 5A includes the negative electrode 931, the positive electrode 932, and the separators 933. The negative electrode 931 includes a negative electrode active material layer 931a. The positive electrode 932 includes a positive electrode active material layer 932a.

The separator 933 has a larger width than the negative electrode active material layer 931a and the positive electrode active material layer 932a, and is wound to overlap with the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high level of safety and high productivity.

As illustrated in FIG. 5B, the negative electrode 931 is electrically connected to the terminal 951 by ultrasonic bonding, welding, or pressure bonding. The terminal 951 is electrically connected to a terminal 911a. The positive electrode 932 is electrically connected to the terminal 952 by ultrasonic bonding, welding, or pressure bonding. The terminal 952 is electrically connected to a terminal 911b.

As illustrated in FIG. 5C, the wound body 950a and an electrolyte solution are surrounded by the housing 930, whereby the secondary battery 913 is completed. The housing 930 is preferably provided with a safety valve and an overcurrent protection element. A safety valve is a valve to be released at a predetermined internal pressure of the housing 930 in order to prevent the battery from exploding.

As illustrated in FIG. 5B, the secondary battery 913 may include a plurality of wound bodies 950a. The use of the plurality of wound bodies 950a enables the secondary battery 913 to have higher charge and discharge capacity. The description of the secondary battery 913 in FIG. 4A to FIG. 4C can be referred to for the other components of the secondary battery 913 in FIG. and FIG. 5B.

Since the housing 930 corresponds to the exterior body, the temperature sensitive paint layer is applied to a part of a surface of the housing 930, whereby the state of heat generation can be captured by the imaging device.

Furthermore, the temperature sensitive paint layer may be applied to the top surface where the terminal 911a is provided (the top surface of the secondary battery 913) for the terminal 951. Note that it is preferable that the terminal 951 be not provided in contact with the terminal 911a so as not to hinder the electrical connection. Laying the secondary batteries 913 close to each other so that side surfaces are in contact with each other makes measurement by the imaging device difficult in some cases; however, when the temperature sensitive paint layer is applied to the top surface of the secondary battery 913, the abnormality detection with the use of the imaging device becomes possible.

This embodiment can be freely combined with the other embodiments.

### Embodiment 5

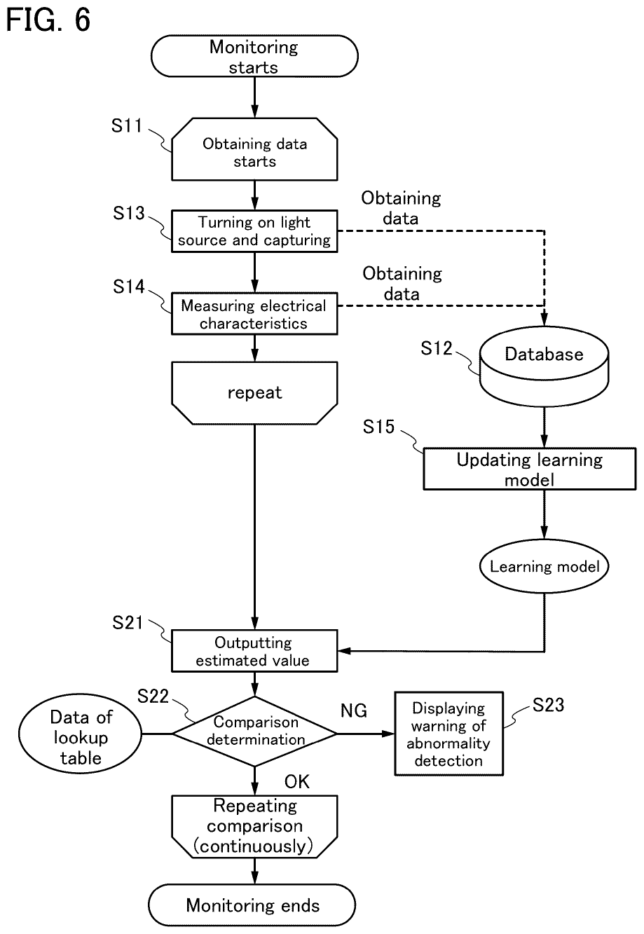

In this embodiment, an example of a flow for monitoring the abnormal heat generation of the secondary battery using the monitoring system described in Embodiment 1 is illustrated in FIG. 6.

Data is obtained before activating a motor of an electric vehicle that incorporates the monitoring system described in Embodiment 1.

Preparation for obtaining data for predicting abnormal heat generation of a secondary battery starts (S11).

The light source provided in the vicinity of the secondary battery is turned on, and the external view of the secondary battery is captured (S13). The temperature sensitive paint layer is applied on the secondary battery, so that when being irradiated with light from the light source, a portion of the temperature sensitive paint layer overlapping with an abnormal heat source emits light. Data, the light emission, is obtained as image data by the imaging device such as a CCD or the image sensor. A driver can recognize whether the secondary battery has an abnormality or not with the display portion before the motor is activated. The imaging device such as the CCD is inexpensive compared to a thermal camera which performs imaging of thermography. The detection of the light emission from the temperature sensitive paint layer is advantageous and useful in detecting a wide range of light emission instantly. In the case of using a thermometer for each secondary battery, data can be obtained only in a narrow temperature range, and detection for a wide temperature range is difficult; in the case of using 1000 or more secondary batteries, the same number of thermometers is to be prepared, resulting in high cost. The monitoring system described in Embodiment 1 can afford a large-sized secondary battery or 5000 secondary batteries with one or more imaging devices for detecting the light emission from the temperature sensitive paint layer.

In the case where abnormal heat generation cannot be detected from the obtained image data and the secondary battery is recognized as normal, the driver activates the motor of the electric vehicle using the secondary battery.

Next, electrical characteristics for voltage, current, and internal temperature of the secondary battery are measured (S14). In this way, data on the electrical characteristics is obtained.

The obtained data and the data on the electric characteristics are stored in a database (S12).

Driving of the electric vehicle starts. Then, the image data and the data on the electrical characteristics are stored in the database at a regular or irregular timing.

At the stage when the data for creating or updating a learning model is obtained, the learning model is updated (S15). To construct a model by an ensemble learning algorithm, a prepared dataset is divided into two, training data and test data, to create a predictive model and to perform evaluation thereon.

Data for learning may be prepared in advance for the database. For example, past data collected in previous driving or learning data obtained beforehand by an electric-vehicle manufacturer is obtained. Such data is stored in advance in the database. The database may be updated as appropriate directly or indirectly (wirelessly) from an external device (an external server).

When the update of the leaning model ends, the driving restarts. In this embodiment, steps from S11 to S15 can be regarded as a first stage for leaning.

A second stage for the estimation is shown below.

The neural network processing is performed using the learning model on the basis of the image data or the data on the electric characteristics, and an estimated value is output (S21).

Next, a third stage for abnormality detection is shown below.

The present estimated value is compared with an estimated value that is the last estimation result and a determination is made (S22). A difference between the last estimated value and the present estimated value (absolute value) is used as a reference for abnormality determination. As data of a lookup table, the size of the difference regarded as abnormality detection and the corresponding temperature are stored.

When the difference, that is, a variation in estimated value is larger than the data of the lookup table, a secondary battery is determined as abnormal, and a warning of abnormality detection is displayed to a driver of the vehicle (S23).

When the difference, that is, a variation in estimated values is smaller than the data of the lookup table, a secondary battery is determined as normal.

The vehicle can continue running safely while performing the update of the learning model and the abnormality detection by repeating the first stage, the second stage, and the third stage during the running as described above. Not an enormous amount of data during the running but the relatively small amount of data (data within a short time period around the temporary stop) is used, whereby the memory capacity and the calculation amount can be reduced, and highly accurate estimation and abnormality detection can be performed.

According to this embodiment, a driver can drive safely, not only recognizing the external view of the secondary battery freely when having concerns, but also making the neural network processing perform an abnormality detection with high accuracy.

In this embodiment, checking an abnormality in both the image data and the data on the electrical characteristics can be performed in real time, whereby safety can be enhanced.

This embodiment can be implemented in appropriate combination with the other embodiments.

### Embodiment 6

In this embodiment, examples of a monitoring system of a secondary battery of one embodiment of the present invention, mounted on a vehicle, typically a transport vehicle, and a monitoring system of a secondary battery equipped in a building will be described.

Mounting the secondary battery illustrated in any one of FIG. 2A, FIG. 3A, FIG. 5A, FIG. 4B, or FIG. 5C on vehicles can provide next-generation clean energy vehicles such as hybrid vehicles (HVs), electric vehicles (EVs), and plug-in hybrid vehicles (PHVs). The secondary battery can also be mounted on transport vehicles such as agricultural machines, motorized bicycles including motor-assisted bicycles, motorcycles, electric wheelchairs, electric carts, boats or ships, submarines, aircraft such as fixed-wing aircraft and rotary-wing aircraft, rockets, artificial satellites, space probes, planetary probes, and spacecraft. In the monitoring system of one embodiment of the present invention, the temperature sensitive paint layer applied on the exterior body of the secondary battery emits light, so that an abnormality can be checked remotely from the external view. Thus, the secondary battery of one embodiment of the present invention can be suitably used in transport vehicles.

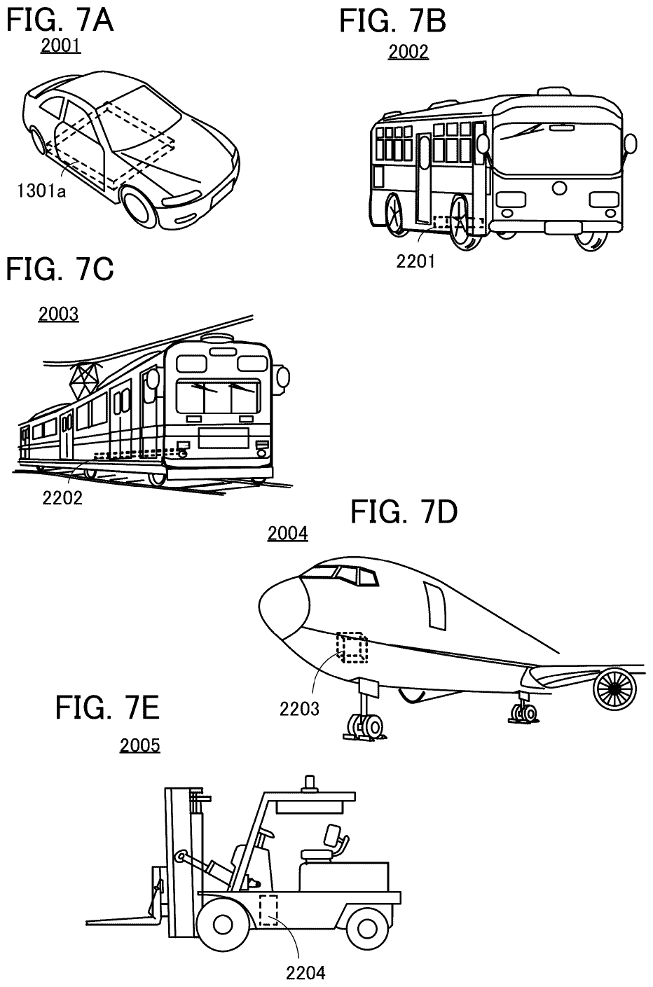

FIG. 7A to FIG. 7E illustrate examples of transport vehicles using one embodiment of the present invention. An automobile 2001 illustrated in FIG. 7A is an electric vehicle that uses an electric motor as a driving power source. Alternatively, the automobile 2001 is a hybrid electric vehicle that can appropriately select an electric motor or an engine as a driving power source. In the case where the secondary battery of one embodiment of the present invention is mounted on a vehicle, the temperature sensitive paint layer applied on the external body of the secondary battery emits light, so that an abnormality can be checked remotely from the external view. The automobile 2001 illustrated in FIG. 7A includes a battery pack 1301a, and the battery pack 1301a includes a secondary battery module in which a plurality of secondary batteries are connected to each other. Moreover, the battery pack preferably includes a charge control device that is electrically connected to the secondary battery module. In order to cut off electric power from the plurality of secondary batteries, the secondary batteries in the electric vehicle include a service plug or a circuit breaker which can cut off a high voltage without the use of equipment. For example, in the case where 48 battery modules which each include two to ten cells are connected in series, a service plug or a circuit breaker is placed between the 24th battery module and the 25th battery module. In the case where an abnormality detection system of one embodiment of the present invention is mounted on the automobile 2001, an abnormality detection of the secondary battery can be performed by neural network processing; accordingly, a danger avoidance system may be provided in which the power source is cut off by operating the service plug or the circuit breaker when the secondary battery is determined as dangerous on the basis of an inference by the neural network portion. In addition to the abnormality detection system of one embodiment of the present invention, a driving assistance system may be constructed by a combination with an environment recognition unit, for example, a stereo camera, a sonar, a multifocal multi-eye camera system, a LIDAR, a millimeter-wave radar, an infrared sensor (a TOF system), or the like. Since the neural network portion makes an inference for image recognition also in the driving assistance system, the common program and IC chip can be used for part of the arithmetic processing of the driving assistance system and the abnormality detection system using one embodiment of the present invention, whereby reduction in cost or the number of components can be achieved. In distance measurement with the TOF system, a light source and a light detector (a sensor or a camera) are used. A camera used in the TOF system is referred to as a time-of-flight camera, and is also referred to as a TOF camera. The TOF camera can obtain distance information between a light source emitting light and an object on the basis of time of flight of reflected light of light delivered on the object.

The automobile 2001 can be charged when the battery pack 1301a included in the automobile 2001 is supplied with electric power through external charge equipment by a plug-in system or a contactless power feeding system. In charge, a given method such as CHAdeMO (registered trademark) or Combined Charging System can be employed as a charge method or the standard of a connector as appropriate. The charge equipment of the secondary battery may be a charge station provided in a commerce facility or a household power supply. For example, with the use of the plug-in technique, the battery pack 1301a mounted on the automobile 2001 can be charged by being supplied with electric power from the outside. The charge can be performed by converting AC electric power into DC electric power through a converter such as an ACDC converter. A driver sometimes leaves the car unattended during the charge of the battery pack 1301a mounted on the automobile 2001 until the charge ends, in which case an abnormality during the charge is monitored with the use of the neural network processing; in the case where the secondary battery is determined as dangerous by the neural network portion, charge can be suspended. Accordingly, in this embodiment, the driver can leave the car unattended without worry until the charge ends.

Although not illustrated, the vehicle may mount a power receiving device so that the battery pack 1301a can be charged by being supplied with electric power from an above-ground power transmitting device in a contactless manner. In the case of the contactless power feeding system, by fitting a power transmitting device in a road or an exterior wall, charge can be performed not only when the vehicle is stopped but also when driven. In addition, the contactless power feeding system may be utilized to perform transmission and reception of electric power between two vehicles. Furthermore, a solar cell may be provided in the exterior of the vehicle to charge the secondary battery when the vehicle stops or runs. To supply electric power in such a contactless manner, an electromagnetic induction method or a magnetic resonance method can be used.

FIG. 7B illustrates a large transporter 2002 having a motor controlled by electricity, as an example of a transport vehicle. The secondary battery module of the transporter 2002 has a cell unit of four secondary batteries with a nominal voltage of 3.0 V or higher and 5.0 V or lower, and 48 cells are connected in series to have 170 V as the maximum voltage. A battery pack 2201 has a function similar to that in FIG. 7A except for the number of secondary batteries configuring the secondary battery module; thus, the description is omitted.

FIG. 7C illustrates a large transport vehicle 2003 having a motor controlled by electricity as an example. A secondary battery module of the transport vehicle 2003 has 100 or more secondary batteries with a nominal voltage of 3.0 V or higher and 5.0 V or lower connected in series, and the maximum voltage is 600 V, for example. With this structure, a large number of secondary batteries are required to be monitored for safety. Accordingly, the monitoring system described in Embodiment 1 is useful in enhancing a safety level. A battery pack 2202 has a function similar to that in FIG. 7A except for the number of secondary batteries configuring the secondary battery module; thus the description is omitted.

FIG. 7D illustrates an aircraft 2004 having a combustion engine as an example. The aircraft 2004 illustrated in FIG. 7D can be regarded as a kind of transport vehicles since it is provided with wheels for takeoff and landing, and has a battery pack 2203 including a secondary battery module and a charge control device; the secondary battery module includes a plurality of secondary batteries connected to each other.

The secondary battery module of the aircraft 2004 has eight 4 V secondary batteries connected in series and has a maximum voltage of 32 V, for example. The secondary battery module of the aircraft 2004 is required to be monitored for safety. Accordingly, the monitoring system described in Embodiment 1 is useful in enhancing a safety level. The monitoring system described in Embodiment 1 can specify a secondary battery with an abnormality. Thus, emergency exchange can be performed during flight by communicating with an airport control tower using image data of the secondary battery transmitted to the airport control tower. The battery pack 2203 has a function similar to that in FIG. 7A except for the number of secondary batteries configuring the secondary battery module; thus, the description is omitted. The aircraft 2004 incorporates a memory device called a black box, and two components, a flight data recorder and a cockpit voice recorder. A system in which the memory device automatically records image data obtained by monitoring the secondary battery may be employed. This may enable determination whether the abnormality in the secondary battery is attributed or not in the case where an accident occurs. Conventionally, when the secondary battery explodes, it is difficult to find out the cause because no evidence is left.

FIG. 7E illustrates a transport vehicle 2005 that transports freight as an example. The transport vehicle includes a motor controlled by electricity; a variety of operations are performed by electric power supplied from a secondary battery included in a secondary battery module of a battery pack 2204. The transport vehicle 2005 is not limited to be operated by a person riding thereon as a driver and can be operated unmanned with the use of CAN communication. Although FIG. 7E illustrates a forklift as an example, there is no particular limitation; a monitoring system of the secondary battery of one embodiment of the present invention can be mounted on an industrial machine capable of being operated by CAN communication, e.g., an automatic transport machine, a working robot, or small construction equipment.

### [Building]

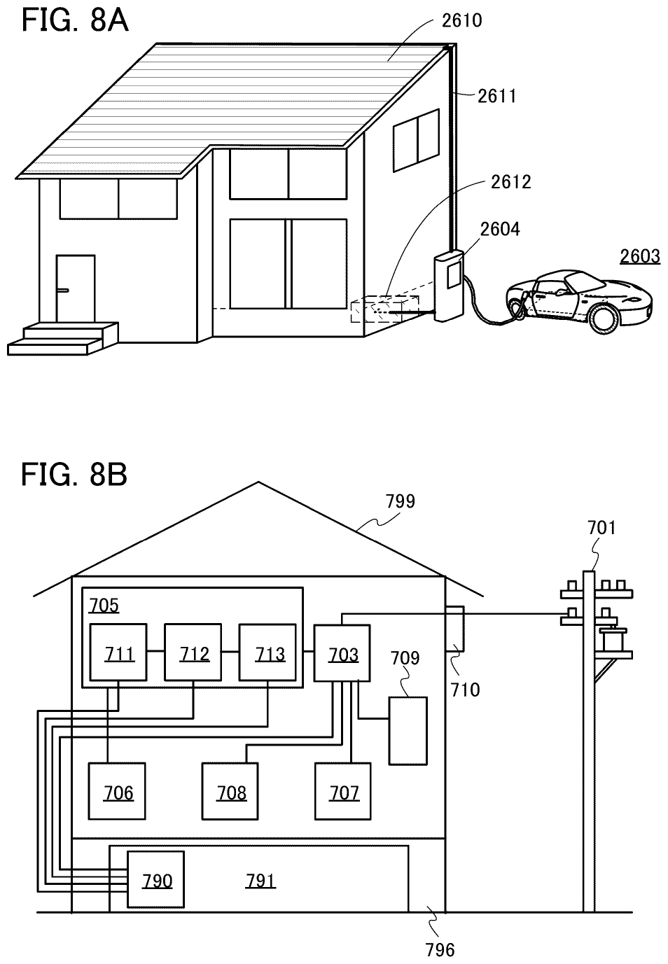

Next, examples in which the secondary battery of one embodiment of the present invention is mounted on a building will be described with reference to FIG. 8.

A house illustrated in FIG. 8A includes a safe power storage device 2612 and a solar panel 2610 with the use of the monitoring system of the secondary battery of one embodiment of the present invention. The power storage device 2612 is electrically connected to the solar panel 2610 through a wiring 2611. The power storage device 2612 may be electrically connected to a ground-based charge device 2604. The power storage device 2612 can be charged with electric power generated by the solar panel 2610. The secondary battery included in a vehicle 2603 can be charged with the electric power stored in the power storage device 2612 through the charge device 2604. The power storage device 2612 is preferably provided in an underfloor space. The power storage device 2612 is provided in the underfloor space, in which case the space on the floor can be effectively used. Alternatively, the power storage device 2612 may be provided on the floor.

The electric power stored in the power storage device 2612 can also be supplied to other electronic devices in the house. Thus, with the use of the power storage device 2612 as an uninterruptible power source, electronic devices can be used even when electric power cannot be supplied from a commercial power source due to power failure.

FIG. 8B illustrates an example of a power storage device 700 of one embodiment of the present invention. As illustrated in FIG. 8B, a large power storage device 791 including the monitoring system of the secondary battery of one embodiment of the present invention is provided in an underfloor space 796 of a building 799. The underfloor space 796 is enclosed and the light source and the imaging device are provided, so that an abnormality detection can be performed on the basis of a light emission from the temperature sensitive paint layer applied on the secondary battery. In the case where abnormal heat generation occurs, it is possible to implement a coping method with the situation correctly by transmitting image data to a manufacturer.

The power storage device 791 is provided with a control device 790, and the control device 790 is electrically connected to a distribution board 703, a power storage controller 705 (also referred to as a control device), an indicator 706, and a router 709 through wirings.

Electric power is transmitted from a commercial power source 701 to the distribution board 703 through a service wire mounting portion 710. Moreover, electric power is transmitted to the distribution board 703 from the power storage device 791 and the commercial power source 701, and the distribution board 703 supplies the transmitted electric power to a general load 707 and a power storage load 708 through outlets (not illustrated).

The general load 707 is, for example, an electric device such as a TV or a personal computer. The power storage load 708 is, for example, an electric device such as a microwave oven, a refrigerator, or an air conditioner.

The power storage controller 705 includes a measuring portion 711, a predicting portion 712, and a planning portion 713. The measuring portion 711 has a function of measuring the amount of electric power consumed by the general load 707 and the power storage load 708 during a day (e.g., from midnight to midnight). The measuring portion 711 may have a function of measuring the amount of electric power of the power storage device 791 and the amount of electric power supplied from the commercial power source 701. The predicting portion 712 has a function of predicting, on the basis of the amount of electric power consumed by the general load 707 and the power storage load 708 during a given day, the demand for electric power consumed by the general load 707 and the power storage load 708 during the next day. The planning portion 713 has a function of making a charge and discharge plan of the power storage device 791 on the basis of the demand for electric power predicted by the predicting portion 712.

The amount of electric power consumed by the general load 707 and the power storage load 708 and measured by the measuring portion 711 can be checked with the indicator 706. It can be checked with an electronic device such as a TV or a personal computer through the router 709. Furthermore, it can be checked with a portable electronic terminal such as a smartphone or a tablet through the router 709. With the indicator 706, the electronic device, or the portable electronic terminal, for example, the demand for electric power depending on a time period (or per hour) that is predicted by the predicting portion 712 can be checked.

When the power storage controller 705 can perform the neural network processing, abnormal heat generation of the secondary battery can be estimated with the use of the temperature sensitive paint layer applied on the secondary battery.

This embodiment can be implemented in appropriate combination with the other embodiments.

### REFERENCE NUMERALS

101: secondary battery, 102: charge control circuit, 103: ammeter, 104: voltmeter, 105: internal temperature sensor, 106: neural network portion, 107: determination portion, 108: memory portion, 109: display portion, 111: imaging device, 112: temperature control mechanism, 113: light source, 150: monitoring system, 500: secondary battery, 501: positive electrode current collector, 502: positive electrode active material layer, 503: positive electrode, 504: negative electrode current collector, 505: negative electrode active material layer, 506: negative electrode, 507: separator, 509: exterior body, 509a: exterior body, 509b: exterior body, 510: positive electrode lead electrode, 511: negative electrode lead electrode, 512: stack, 513: nonaqueous electrolyte solution, 514: region, 520: temperature sensitive paint layer, 601: positive electrode cap, 602: battery can, 603: positive electrode terminal, 604: positive electrode, 605: separator, 606: negative electrode, 607: negative electrode terminal, 608: insulating plate, 609: insulating plate, 611: PTC element, 613: safety valve mechanism, 615: power storage system, 616: secondary battery, 620: control circuit, 623: wiring, 624: conductor, 625: insulator, 626: wiring, 700: power storage device, 701: commercial power source, 703: distribution board, 705: power storage controller, 706: indicator, 707: general load, 708: power storage load, 709: router, 710: service wire mounting portion, 711: measuring portion, 712: predicting portion, 713: planning portion, 790: control device, 791: power storage device, 796: underfloor space, 799: building, 911a: terminal, 911b: terminal, 913: secondary battery, 930: housing, 930a: housing, 930b: housing, 931: negative electrode, 931a: negative electrode active material layer, 932: positive electrode, 932a: positive electrode active material layer, 933: separator, 950: wound body, 950a: wound body, 951: terminal, 952: terminal, 1010: secondary battery, 1301a: battery pack, 2001: automobile, 2002: transporter, 2003: transport vehicle, 2004: aircraft, 2005: transport vehicle, 2200: battery pack, 2201: battery pack, 2202: battery pack, 2203: battery pack, 2204: battery pack, 2603: vehicle, 2604: charge device, 2610: solar panel, 2611: wiring, 2612: power storage device

1. A secondary battery comprising a positive electrode, a negative electrode, and san exterior body,
wherein the exterior body surrounds at least part of the positive electrode and at least part of the negative electrode, and
wherein temperature sensitive paint is on a surface of the exterior body.

2. The secondary battery according to claim 1, further comprising
a temperature sensor.

3. The secondary battery according to claim 1,
wherein the exterior body is a laminate film.

4. The secondary battery according to claim 1,
wherein the exterior body is a metal housing.

5. A monitoring system of a secondary battery, comprising:
the secondary battery comprising a positive electrode, a negative electrode, and an exterior body surrounding at least part of the positive electrode and the negative electrode;
a light source which irradiates the exterior body with light;
an imaging device which captures a surface of the exterior body; and
a neural network portion for estimating abnormal heat generation on the surface of the exterior body,
wherein a temperature change on the surface of the exterior body is captured by the imaging device and an abnormality in the secondary battery is estimated.

6. The monitoring system of the secondary battery, according to claim 5,
wherein temperature sensitive paint is on the surface of the exterior body.

7. The monitoring system of the secondary battery, according to claim 5,
wherein one or more selected from image data captured by the imaging device, an internal temperature of the secondary battery, and voltage, electric power, and current of the secondary battery is used as data learned in the neural network portion and data on the secondary battery.

8. The secondary battery according to claim 2, wherein the exterior body is a laminate film.

9. The secondary battery according to claim 3, wherein the exterior body is a metal housing.

10. The secondary battery according to claim 3, wherein the exterior body is a metal housing.

11. The monitoring system of the secondary battery, according to claim 5,
wherein one or more selected from image data captured by the imaging device, an internal temperature of the secondary battery, and voltage, electric power, and current of the secondary battery is used as data learned in the neural network portion and data on the secondary battery.
